(19) United States
(12) Patent Application Publication
(10) Pub. No.: US 2008/0110145 A1
(43) Pub. Date: May 15, 2008

(54) Compressible filter element

(75) Inventors: Bernhard BEER, Waldbrol (DE); Jorn-Uwe KRUGER, Morsbach (DE); Rolf Daniel MERZ, Numbrecht (DE); Werner GERHARD, Hamm/Sieg (DE); Ulrich STAHL, Laudenbach (DE); Uwe FELBER, Abtsteinach (DE)

Correspondence Address: GROSSMAN, TUCKER, PERREAULT & PFLEGER, PLLC, 55 SOUTH COMMERICAL STREET, MANCHESTER, NH, 03101, US

(73) Assignees: CARL FREUDENBERG KG, Weinheim (DE); MONTAPLAST GMBH, Morsbach (DE)

(21) Appl. No.: 11/762,256

(22) Filed: Jun. 13, 2007

(30) Foreign Application Priority Data
Jun. 14, 2006 (DE) 10 2006 028 039.3
Jun. 29, 2006 (DE) 10 2006 030 410.1

(51) Int. Cl. B01D 46/52; B01D 50/00

(52) U.S. Cl. 55/385.3; 55/497

(57) ABSTRACT

With respect to the object of providing a filter element with a sufficiently high filtration capacity and easy deformability, a filter element, comprising a first component (1), a second component (2) and a pleated filter medium (3) interposed between the components (1, 2), the components (1, 2) being disposed at a distance due to the filter medium (3), is characterized in that the filter element (3) is made of a non-woven fabric and pleated such that a distance between the components (1, 2) can be reversibly reduced, at least in some regions, when a force is applied.

### FIELD OF TECHNOLOGY

The invention relates to a filter element, comprising a first component, a second component and a pleated filter medium interposed between the components, wherein the components are disposed at a distance from each other due to the filter medium.

### STATE OF THE ART

Filter elements of the kind described above are known from the state of the art and are used particularly in engine air filtration applications in motor vehicles, particularly in intake systems. The known filter elements comprise paper as the filter medium, the paper being pleated.

The known filter elements are presently frequently disposed in crumple zones and hence in the crash-relevant regions of a motor vehicle. The problem associated with this configuration is that the known filter elements, due to their compact design and rigid shape, offer great resistance against deformations and thus limit the deformability of the entire intake system. This is particularly critical in the event of impact between a traffic member, such as a pedestrian, and a region of the vehicle body beneath which such a rigid element is disposed.

In the most unfavorable case, a category-defining filter element made of paper is diposed under the vehicle body, for example the hood, in an intake system. In this case, the deformability of the intake system and hence of the body is so severely limited by the category-defining filter element that it creates a considerable risk of injury for the traffic member.

For this reason, the category-defining filter elements must be disposed at such a distance from vehicle body parts that easy deformability of the body and/or the intake system is guaranteed. The consequence is unused installation space, particularly under the hood.

### DESCRIPTION OF THE INVENTION

It is therefore the object of the invention to configure and further develop a filter element of the kind mentioned at the beginning such that it has a sufficiently high filtration performance with easy deformability.

According to the invention, the above object is achieved with the characteristics of claim 1. According to this claim, a filter element is characterized in that the filter medium is made of a non-woven fabric and is pleated such that a distance between the components can be reversibly reduced, at least in some areas, when a force is applied.

According to the invention, it was found that the use of a non-woven fabric is a surprisingly simple way to produce a reversibly deformable filter element, which offers a sufficiently large filtration surface.

In concrete terms, it was found that the filtration performance of paper can also be guaranteed by a non-woven fabric, which is pleated in a certain way and has a lower density of pleats. It was uncovered that the pleat tips of two adjoining pleats can be disposed further away from one another than those of a paper filter medium, which is to say that the density of pleats can be reduced. Disposing the pleats further away from each other allows the pleats to collapse and the distance between the components can thus be easily decreased. Furthermore, it was found that a non-woven fabric is particularly elastic, which enables a reversible deformation of the filter element. This guarantees conditional suitability of the filter element after deformation by an accident, which is referred to as an emergency operating property. In this respect, a filter element is provided, which has easy deformability with sufficiently high filtration performance.

Consequently, the object mentioned above has been achieved.

The distance between the components could be reduced by at least 20%, preferably by at least 75%. This concrete embodiment ensures that a pedestrian hitting the body of a motor vehicle is largely protected from injury. This considerably reduces the risk of injury.

Under these circumstances, it is conceivable that the filter medium has a height h, which can be reduced by at least 20%, preferably by at least 75%. In this concrete embodiment, the components can be made of a hard material and do not have to contribute much to the compressibility of the entire filter element. In this respect, a particularly cost-efficient manufacturing process can be implemented since the components can be made of conventional plastic materials. In particular, however, it is also conceivable that the components are made of a bonded non-woven fabric. In this way, a uniform design of the filter element with respect to the materials used can be achieved.

The compressibility of the filter element, which is to say the force-displacement behavior, could be varied by modifying the non-woven fabric used. This modification could be implemented through the use of fibers having different flexural strength. In doing so, synthetic fibers could be combined with natural fibers in a certain mixing ratio. The rigidity of the non-woven fabric could also be adjusted by using different manufacturing methods. For example, the rigidity of the non-woven fabric could be adjusted through the suitable selection of the parameters using a spunlacing production method.

The non-woven fabric could comprise synthetic fibers, or it could be made entirely of synthetic fibers. It is conceivable that the synthetic fibers are made of polypropylene, polyester or polybutadiene terephthalate. According to DIN ISO 5011, the motor vehicle industry requires a very concrete filtration performance from performance-capable filter elements in intake systems, in particular a separating performance of more than 98%. According to this standard, a filter element only has a sufficiently high filtration performance if 98% of the test dust quantity in the air to be filtered is separated in the filter medium. Surprisingly, it was found that a non-woven fabric comprising synthetic fibers meets these requirements, while having easy deformability. The easy deformability is implemented substantially by a relatively wide distance of the pleats.

The filter medium could be made of a thermoplastic non-woven fabric. Surprisingly, a thermoplastic non-woven fabric has a high compressibility level in the pleated state. Experiments have shown that a pleated non-woven fabric measuring 48 mm in height, on which a force is applied in the direction of the pleat tip, can be compressed by 28.32 mm at 100 N. At 0 N, 5 N, 10 N, 20 N and 50 N, the analyzed non-woven fabric can be compressed in the height thereof by 0 mm, 0.4 mm, 2.76 mm, 9.54 mm and 17.23, respectively. The force vector is oriented parallel to the pleat tips in this measurement. The thermoplastic non-woven fabric used is a non-woven fabric made of polyester fibers. The non-woven fabric has no binding agent and the fibers are rather fused together by thermal bonding methods. The non-woven fabric has a basis weight of 230 g/m².

It is also conceivable to use non-woven fabrics with basis weights of 100 to 500 g/m². Non-woven fabrics with these types of basis weights have a sufficiently high inherent rigidity to dispose two components at a distance from one another and at the same time provide a sufficiently high filtration performance.

Furthermore, the use of a non-woven fabric surprisingly allows the components to be spaced solely by the filter medium since the non-woven fabric due to the fiber structure thereof has a sufficiently high inherent rigidity. Unlike paper, even after drenching and subsequent drying a non-woven fabric has very high ultimate tensile strength and thus stability. Finally, a non-woven fabric made of synthetic material has a high temperature stability and is therefore suited for applications in engine compartments of motor vehicles. Further stabilizing means that support the filter medium in the spacing of the components are not essential. In this way, cost-efficient production of the filter element can be achieved. It is possible, however, to provide further stabilizing means in order to adjust the deformability of the filter element in a defined manner.

The filter medium could have pleats, the pleat fronts facing the components. This concrete embodiment allows easy connection of the filter medium with the components. Under these circumstances, it is conceivable, for example, that an adhesive is associated with the components, wherein the pleat fronts are immersed in this adhesive and establish a bond with the components.

In concrete terms, it also conceivable that the pleats are provided with predetermined bending points, which bring about defined buckling of the filter medium when a force is applied. In particular, it is conceivable that contours are impressed on the pleats, the contours defining or introducing defined buckling of the pleats when a force is applied on the components. The predetermined bending points could be impressed on the filter medium by ultrasonic welding processes. Ultrasonid welding processes can be carried out particularly quickly and cost-efficiently and enable easy tapering of the filter medium in some areas. It is also conceivable to implement an impression of the filter medium solely by force application.

So as to bring about easy deformability of the filter element, the pleat tips could enclose an angle different from 90° with the base surfaces of the components. The pleat tips inclined this way can then be easily deformed by bringing the components closer together.

It is also conceivable that two or more pleats are connected to one another at defined distances such that the pleat walls or pleat flanks bear on one another. Areas of two or more connected pleats could be disposed at a distance from each other by a defined number of non-connected pleats. In very concrete terms, however without limiting the invention, for example, after every five pleats two pleats could be connected. In this way, the deformability of the filter element can be adjusted. The pleat walls could be glued, welded or positively connected to one another. Gluing establishes a very tight bond. Welding can be implemented after reinforcing the pleats. The positive bond allows detaching of the pleats from each other under certain circumstances.

The pleat tips of two adjoining pleats could have a distance of 0.5 to 3 cm. The selection of the distance from this range has proven to be particularly advantageous in order to provide easy deformability of the filter medium on the one hand and to provide a sufficiently large effective filtration surface on the other hand, which is required for engine air filtration. Filter media made of paper cannot achieve a sufficiently high filtration performance, which is to say any of the separation rates required by the motor vehicle industry, at such a distance of the pleat tips and are therefore not suited for intake systems.

At least one component could be made of a material, which is harder or has greater flexural strength than the filter medium. This concrete embodiment enables the production of a stable filter element, which protects the filter medium from the effects of impact and shock. Furthermore, the filter medium is protected from pollution. Under these circumstances, it is conceivable that at least one component is made of a bonded non-woven fabric.

To be able to implement cost-efficient production, at least one component could be produced by injection molding. It is conceivable to produce the components from polypropylene or polyamide.

At least one component could be manufacturing by a foaming method. Such a component creates an excellent bond with the filter medium because the foamed material can enclose the pleats of the filter medium. Polyurethane could be used as a foamed material. This material is easy to process.

It is also conceivable to produce the components from metals. Metals lend the filter element high stability and temperature resistance.

At least one component could have a passage. This guarantees that pipes, hoses or other lines for a medium to be filtered can be connected to the filter element. Under these circumstances, in a very concrete embodiment it is conceivable that the components enclose a filter medium in a sandwich-like manner, wherein the components and the filter medium form the walls of a volume. The medium to be filtered can flow into this volume through the filter medium, which is to say a wall of the filter element, and can be discharged through the passage in the filtered state. Of course, it is also possible to reverse the flow direction, which is to say that the unfiltered medium enters through the passage and is discharged through the wall.

The passage could be associated with sealing means acting as detent means. This concrete embodiment enables the connection of the passage to a hose, a pipe or another line, wherein on the one hand an elastic seal and on the other a force-fit connection are created. In a very concrete embodiment, it is conceivable that the sealing means is configured as a sealing lip with a projection, behind which a counterpiece can engage.

Detent means could be associated with at least one component, the means being configured as one piece with the component and engageable in a complementary detent means receiving element of an air filter housing. These detent means could protrude in a tongue shape from the edge of the component. In concrete terms, it is conceivable that the tongue-shaped detent means are disposed peripherally around a component. In this way, the filter element can engage in an air filter housing of a motor vehicle without the use of additional fastening means.

At least one component could be associated with predetermined breaking means, which dispose the components at a distance from one another, in addition to the filter medium. In this way, the use of a very soft and very easily defomable filter medium is possible since the spacing of the components is primarily assumed by the predetermined breaking means. The predetermined breaking means could be configured such that they break when a very concrete force is applied on the components and guarantee deformability of the filter element.

It is also conceivable to dispose resilient and deformable stabilizing elements between the components. In this way, compressing and rebounding of the components is possible. In a concrete embodiment, the stabilizing elements could be configured as spiral springs or leaf springs since these are very mechanically stable and easy to adjust with respect the spring rate.

The filter element could be configured as an air filter of a motor vehicle. The easy deformability of the filter element according to the invention is excellently suited to provide the element in a motor vehicle directly under the hood, where typically air filters are installed. Under these circumstances, it is conceivable that a component acts as a cover for the volume in the air filter housing in which the filter element is inserted. The component could be associated by the factory with gaskets to seal the volume in the air filter housing. In this way, a fast assembly process can be achieved.

Various possibilities are available for advantageously configuring and further developing the method of the present invention. For this, reference is made to the claims below on the one hand, and on the other hand to the explanation below of preferred examples of the inventive filter element based on the drawing.

Generally preferred embodiments and further developments of the teaching are also explained in conjunction with the explanation of the preferred embodiments of the invention with reference to the drawing.

### BRIEF DESCRIPTION OF THE DRAWING

The drawings show:

FIG. 1 is a sectional view of a filter element comprising two components and one filter medium,

FIG. 2 is a top view of a component of a filter element according to FIG. 1,

FIG. 3 is a passage region in a component of the filter element according to FIG. 1, and

FIG. 4 is a filter element made of a stabilizing element configured as a spiral spring.

### EXECUTION OF THE INVENTION

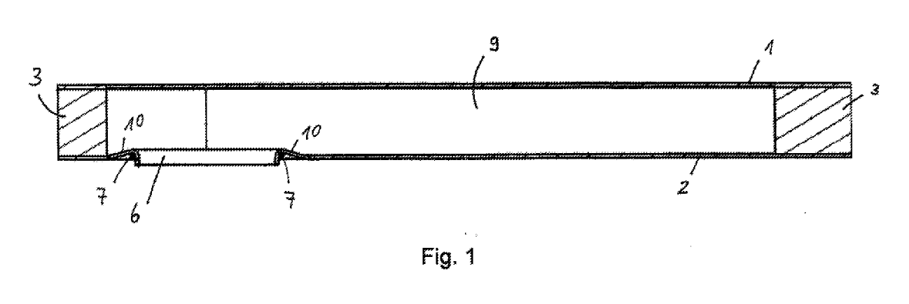

FIG. 1 shows a first component 1, a second component 2 and a pleated filter medium 3 interposed between the components 1, 2. The components 1, 2 are disposed at a distance from one another due to the filter medium 3. The filter medium 3 is made of a non-woven fabric and pleated such that a distance between the components 1, 2 can be reversibly reduced, at least in some regions, when a force is applied on the components.

Due to the inherent rigidity, the filter medium 3 acts as a supporting material and can be used without difficulty as an individual part for disposing the two components 1, 2 at a distance from each other, without further stabilizing means. The filter medium 3 together with the components 1, 2 delimits a volume 9. Component 2 comprises a passage to which lines to the volume 9 can be flange-connected. The passage 6 is associated with a ramp-shaped region 10 and a sealing means 7.

The medium to be filtered enters the volume 9 via the filter medium 3 and is filtered in the process. The filtered medium is then discharged again from the volume 9 via the passage 6.

A medium to be filtered may also enter the volume 9 of the filter element via the passage 6 and then be discharged via the filter medium 3. The volume 9 is delimited by the components 1, 2 and the filter medium 3.

The distance between the two components 1, 2 can be reduced by at least 20%, preferably by at least 75%. The filter medium 3 is made of a thermoplastic non-woven fabric.

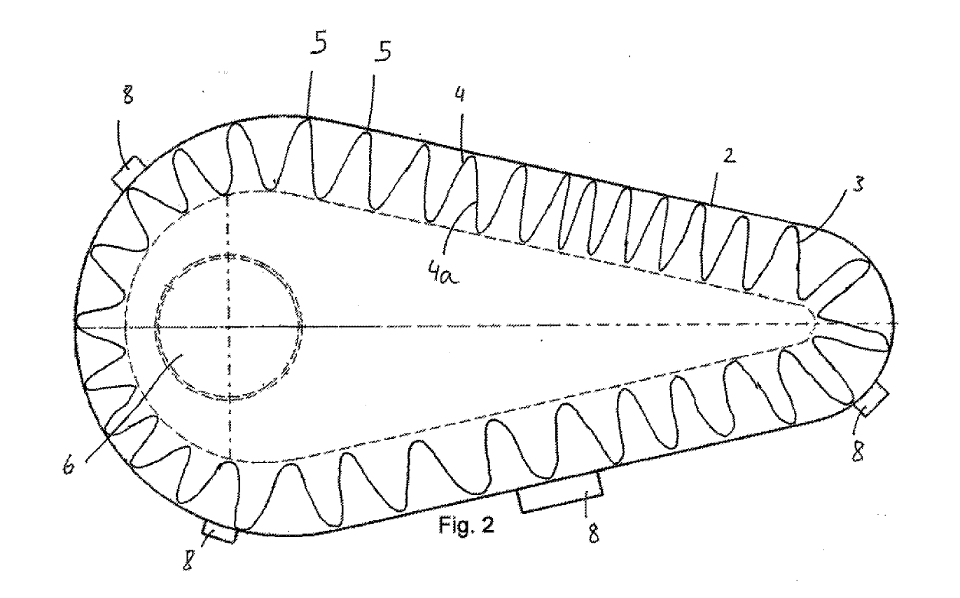

FIG. 2 shows a top view of a component 2, which is associated with a filter medium 3 made of a thermoplastic non-woven fabric. The filter medium 3 has pleats 4, the pleat fronts 4a thereof facing the components 1, 2. One pleat front 4a faces the component 2 such that the pleat fronts 4a are immersed in an adhesive. In this way, a bond is established between the component 2 and the filter medium 3.

The pleat tips 5 of two adjoining pleats have a distance of 0.5 to 3 cm.

The components 1, 2 are made of a material that is harder than the filter medium 3. The components 1, 2 are produced by injection molding and are made of polypropylene.

It is apparent from FIG. 2 that the filter element has a wedge-shaped or drop-shaped design. The pleated filter medium 3 made of a thermoplastic non-woven fabric is received in a sandwich-like manner between the component 2 and the component 1, which is not shown. Component 2 has a passage 6.

Detent means 8 are associated with the component 2, the means being configured as one piece with the component 2 and engageable in complementary detent means receiving elements of an air filter housing. The detent means 8 protrude from the edge of the component 2 in a tongue shape. The tongue-shaped detent means 8 are disposed peripherally around the component 2. In this way, the filter element can engage in an air filter housing of a motor vehicle without the use of additional fastening means.

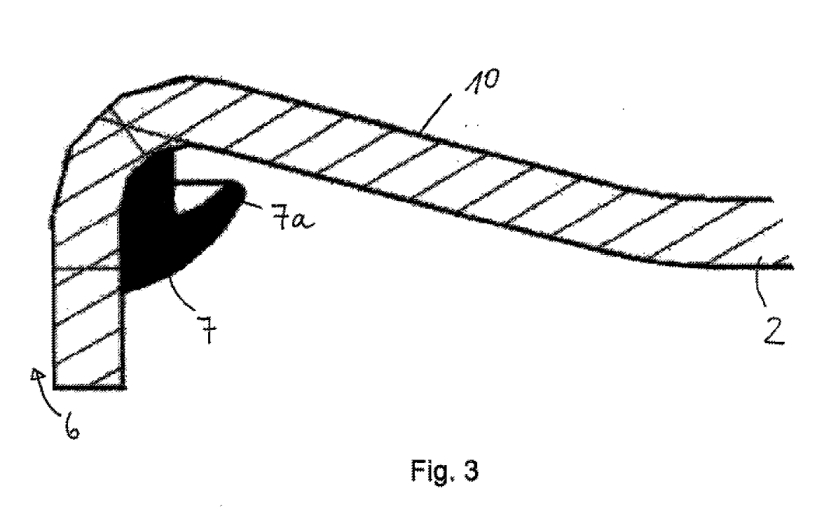

FIG. 3 shows a section of the component 2 according to FIG. 1, which is connected to the component 1 by a filter medium 3. The component 2 has a passage 6, which is associated with a sealing means 7. The sealing means 7 is configured as a sealing lip made of thermoplastic ethylene.

The sealing means 7 has a projection 7a acting as a detent means, in which a counterpiece can engage. The counterpiece may be configured as a hose, pipe or line for media to be filtered or already filtered.

The passage 6 is associated with a ramp-shaped region 10, which brings about a particularly advantageous flow behavior of the media to be filtered in the relatively narrow volume 9.

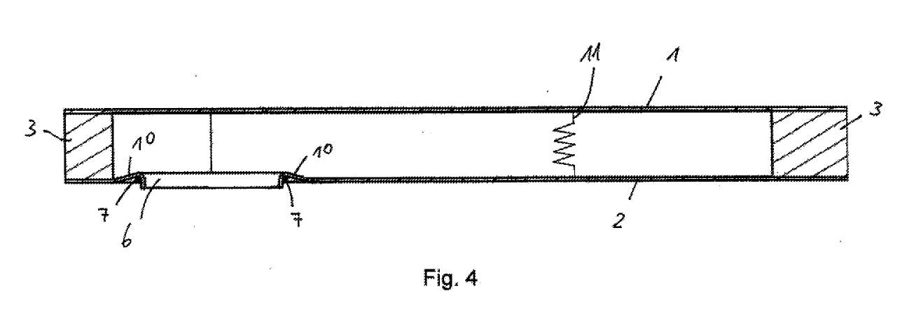

FIG. 4 shows a first component 1, a second component 2 and a pleated filter medium 3 interposed between the components 1, 2. The components 1, 2 are disposed at a distance from one another due to the filter medium 3. The filter medium 3 is made of a non-woven fabric and pleated such that a distance between the components 1, 2 can be reversibly reduced, at least in some regions, when a force is applied on the components.

Due to the inherent rigidity, the filter medium 3 acts as a supporting material and together with a stabilizing element 11 disposes the two components 1, 2 at a distance. The stabilizing element 11 is configured as a spiral spring and brings about compressing and rebounding of the components 1, 2. In particular, following a deformation of the filter medium 3 the spiral spring 11 can space the two approaching components 1, 2 again and return them to the original position.

The filter medium 3 together with the components 1, 2 delimits a volume 9. Component 2 comprises a passage to which lines to the volume 9 can be flange-connected. The passage 6 is associated with a ramp-shaped region 10 and a sealing means 7.

With respect to further advantageous embodiments and further developments of the teaching according to the invention, reference is made on the one hand to the general part of the description and on the other hand to the attached claims.

Finally, it shall be noted in particular that the above arbitrarily selected exemplary embodiments only serve the explanation of the inventive teaching, however they do not limit it to these exemplary embodiments.

What is claimed is:

1. A filter element, comprising a first component, a second component and a pleated filter medium interposed between the components, the components being disposed at a distance from one another due to the filter medium, characterized in that the filter medium is made of a non-woven fabric and is pleated such that a distance between the components is reversibly reduced, at least in some areas, when a force is applied.

2. The filter element according to claim 1, characterized in that the distance can be reduced by at least 20%, preferably by at least 75%.

3. The filter element according to claim 1, characterized in that the filter medium has a height, which can be reduced by at least 20%, preferably by at least 75%.

4. A filter element according to claim 1, characterized in that the filter medium is made of a non-woven fabric comprising synthetic fibers or different fibers with varying flexural strength.

5. A filter element according to claim 1, characterized in that the filter medium is made of a thermoplastic non-woven fabric.

6. A filter element according to claim 1, characterized in that the filter medium has pleats, the pleat fronts thereof facing the components.

7. A filter element according to claim 1, characterized in that the pleat tips of two adjoining pleats have a distance of 0.5 to 3 cm.

8. A filter element according to claim 1, characterized in that the pleats are provided with predetermined bending points.

9. A filter element according to claim 1, characterized in that two or more pleats are connected to one another at defined distances such that the pleat walls or pleat flanks bear on one another at least in some regions.

10. A filter element according to claim 1, characterized in that at least one component is made of a material that is harder than the filter medium.

11. The filter element according to claim 10, characterized in that at least one component is produced by injection molding.

12. A filter element according to claim 1, characterized in that at least one component has a passage.

13. The filter element according to claim 12, characterized in that the passage is associated with sealing means acting as detent means.

14. A filter element according to claim 1, characterized in that at least one component is associated with detent means, which are configured as one piece with the component.

15. A filter element according claim 1, characterized in that at least one component is associated with predetermined breaking means.

16. A filter element according to claim 1, characterized in that at least one component is associated with elastic stabilizing elements.

17. A filter element according to claim 1, characterized by a configuration as an air filter for a motor vehicle.
